(19) United States
(12) Patent Application Publication
(10) Pub. No.: US 2021/0030189 A1
(43) Pub. Date: Feb. 4, 2021

(54) ADJUSTABLE BREWER STRUCTURE

(71) Applicant: Chung-Tao Fan, Taipei City (TW)

(72) Inventor: Chung-Tao Fan, Taipei City (TW)

(21) Appl. No.: 16/531,088

(22) Filed: Aug. 4, 2019

(51) Int. Cl. A47J 31/06

(52) U.S. Cl. CPC A47J 31/0621; A47J 31/0626

(57) ABSTRACT

An adjustable brewer structure, which is applicable for an object to be brewed and a container used for the purpose of brewing, and includes: an outer cylinder, disposed inside the container, wherein the bottom end thereof is provided with a bottom plate formed with at least one penetrated hole and the center thereof is formed with an accommodation space, and the periphery thereof is formed with at least one penetrated hole; and an inner cylinder, disposed in the accommodation space of the outer cylinder, wherein the bottom end thereof is provided with a bottom plate formed with at least one penetrated hole and the center thereof is formed with an accommodation space allowing the object to be brewed to be accommodated therein, and the periphery thereof is formed with at least one penetrated hole corresponding to the penetrated hole at the periphery of the outer cylinder.

### BACKGROUND OF THE INVENTION

### 1. Field of the Invention

The present invention relates to a brewer structure, especially to an adjustable brewer structure in which an outer cylinder and an inner cylinder are respectively provided with a bottom plate, the periphery of the outer cylinder having a flange and the periphery of the inner cylinder having a turning plate are respectively formed with at least one penetrated hole which are corresponding to each other and capable of being arranged to be staggered or aligned, the upper portion of the outer cylinder is formed with a positioning recess or formed with a linear groove having horizontal mounting grooves corresponding to the turning plate of the inner cylinder.

### 2. Description of Related Art

A conventional object to be brewed, such as tea leaves, coffee powers and flower pedals are directly disposed in a tea cup or a tea pot for the purpose of brewing; because the object to be brewed are only disposed in the tea cup or the tea pot without any enclosing device which can provide functions of enclosing and adjusting, thus the object to be brewed can only be disposed in the tea cup or the tea pot for a long period of time and the concentration of the object to be brewed cannot be adjusted to satisfy personal tastes; as such, the above-mentioned disadvantage of not being practical in use shall be seriously concerned by the skilled people in the art.

### SUMMARY OF THE INVENTION

For solving the disadvantage existed in the prior art, one primary objective of the present invention is to provide an adjustable brewer structure including an outer cylinder and an inner cylinder; the outer cylinder and the inner cylinder can be mutually sleeved and respectively provided with a bottom plate, the periphery of the outer cylinder and the periphery of the inner cylinder are respectively formed with at least one penetrated hole which are corresponding to each other; accordingly, the present invention is able to overcome the disadvantage existed in the prior art.

Another objective of the present invention is to provide an adjustable brewer structure, in which via rotating or upwardly/downwardly displacing an inner cylinder in an accommodation space of an outer cylinder, at least one penetrated hole of the inner cylinder and at least one penetrated hole of the outer cylinder can be staggered or aligned, thereby controlling and adjusting the dimension of the penetrated holes.

Another objective of the present invention is to provide an adjustable brewer structure, which is provided with an advantage of efficient operating convenience, the concentration of an object to be brewed accommodated in an accommodation space of an inner cylinder can be adjusted and can be individually served as a tea bag or disposed on a container with a hanging or hooking manner.

One problem to be solved by the present invention is that a conventional object to be brewed, such as tea leaves, coffee powers and flower pedals are directly disposed in a tea cup or a tea pot for the purpose of brewing; because the object to be brewed are only disposed in the tea cup or the tea pot without any enclosing device which can provides functions of enclosing and adjusting, thus the object to be brewed can only be disposed in the tea cup or the tea pot for a long period of time and the concentration of the object to be brewed cannot be adjusted to satisfy personal tastes, so the practicability is very much limited.

One technical solution provided by the present invention for achieving the above-mentioned objectives is to provide an adjustable brewer structure, which is applicable for an object to be brewed and a container used for the purpose of brewing, and includes:

an outer cylinder, disposed inside the container, wherein the bottom end thereof is provided with a bottom plate and the center of the outer cylinder is formed with an accommodation space, and the periphery of the outer cylinder is formed with at least one penetrated hole; and

an inner cylinder, disposed in the accommodation space of the outer cylinder, wherein the bottom end of the inner cylinder is provided with a bottom plate and the center of the inner cylinder is formed with an accommodation space allowing the object to be brewed to be accommodated therein, and the periphery of the inner cylinder is formed with at least one penetrated hole corresponding to the penetrated hole at the periphery of the outer cylinder.

Wherein, according to the present invention, the shape of the outer cylinder and the shape of the inner cylinder are respectively formed in a corresponding tubular shape or a polygonal shape.

Wherein, according to the present invention, the at least one penetrated hole at the periphery of the outer cylinder is formed as an axially-oriented rectangular penetrated hole or formed as a plurality of round penetrate holes.

Wherein, according to the present invention, the at least one penetrated hole at the periphery of the inner cylinder is formed as an axially-oriented rectangular penetrated or formed as a plurality of round penetrate holes, and corresponding to the at least one penetrated hole at the periphery of the outer cylinder which is formed as the plural round penetrate holes or formed as the axially-oriented rectangular penetrated hole.

Wherein, according to the present invention, the top end defined at the periphery of the outer cylinder is formed with a flange, which is outwardly extended and disposed at the top end of the container.

Wherein, according to the present invention, the outer side of the outer cylinder is formed with at least one hooking hanger used for being hooked or hanged at the top end of the container.

Wherein, according to the present invention, the upper portion of the outer cylinder is formed with at least one positioning recess.

Wherein, according to the present invention, the upper portion of the outer cylinder is formed with at least one linear groove and a plurality of horizontal mounting grooves transversally formed along the linear groove and sequentially arranged.

Wherein, according to the present invention, the upper portion of the inner cylinder is provided with a turning plate, which is corresponding to the flange outwardly extended from the top end or the upper portion of the outer cylinder or the at least one positioning recess or the plural horizontal mounting grooves of the at least one linear groove formed at the upper portion of the outer cylinder.

Wherein, according to the present invention, the bottom plate of the outer cylinder and the bottom plate of the inner cylinder are respectively formed with at least one penetrated hole which are corresponding to each other.

Comparing to the prior art, the present invention utilizes the outer cylinder and the inner cylinder which can be mutually sleeved and respectively provided with the bottom plates, the periphery of the outer cylinder having the flange and the periphery of the inner cylinder having the turning plate are respectively formed with the at least one penetrated hole which are corresponding to each other, the upper portion of the outer cylinder is formed with the positioning recess or formed with the linear groove having the horizontal mounting grooves corresponding to the turning plate of the inner cylinder; as such, via rotating or upwardly/downwardly displacing the inner cylinder in the accommodation space of the outer cylinder, the penetrated hole of the inner cylinder and the penetrated hole of the outer cylinder can be staggered or aligned, thereby controlling and adjusting the dimension of the penetrated holes; thus, an efficient operating convenience is provided to the present invention, the concentration and flavor of the object to the brewed accommodated in the accommodation space of the inner cylinder is able to be adjusted and can be individually served as a tea bag or disposed on the container with a hanging or hooking manner; accordingly, the present invention is novel and more practical in use comparing to prior arts.

### BRIEF DESCRIPTION OF THE DRAWINGS

FIG. 1 is a perspective exploded view according to the present invention;

FIG. 2 is a perspective view showing the assembly according to the present invention;

FIG. 3 is a cross sectional view showing the assembly according to the present invention;

FIG. 4 is a schematic view showing the outer cylinder being provided with a hooking hanger and being hanged inside the container according to one preferred embodiment of the present invention;

FIG. 5 is a schematic view showing the outer cylinder being provided with two hooking hangers and being hanged inside the container according to one preferred embodiment of the present invention;

FIG. 6 is a schematic view showing the periphery defined at the top end of the outer cylinder being formed with a flange outwardly extended and disposed at the top end of the container according to one preferred embodiment of the present invention;

FIG. 7 is a schematic view showing the periphery of the outer cylinder being formed with axially-oriented rectangular penetrated holes and the periphery of the inner cylinder being correspondingly formed with round penetrated holes according to one preferred embodiment of the present invention;

FIG. 8 is a schematic view showing the periphery of the outer cylinder being formed with a plurality of round penetrated holes and the periphery of the inner cylinder being correspondingly formed with axially-oriented rectangular penetrated holes according to one preferred embodiment of the present invention;

FIG. 9 is a schematic view showing the upper portion of the outer cylinder being formed with at least one positioning recess according to one preferred embodiment of the present invention;

FIG. 10 is a schematic view showing the upper portion of the outer cylinder being formed with at least one linear groove and a plurality of horizontal mounting grooves being transversally formed along the linear groove and sequentially arranged in the linear groove according to one preferred embodiment of the present invention; and

FIG. 11 is a schematic view showing the outer cylinder and the inner cylinder being rotated for adjusting the dimension of the penetrated holes thereof according to one preferred embodiment of the present invention.

### DETAILED DESCRIPTION OF THE PREFERRED EMBODIMENT

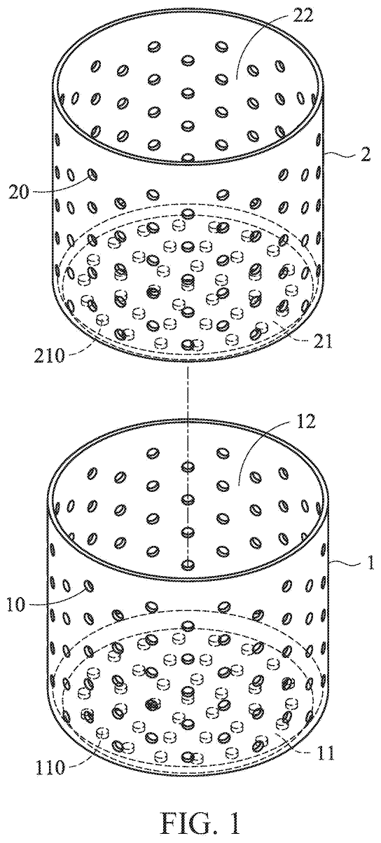

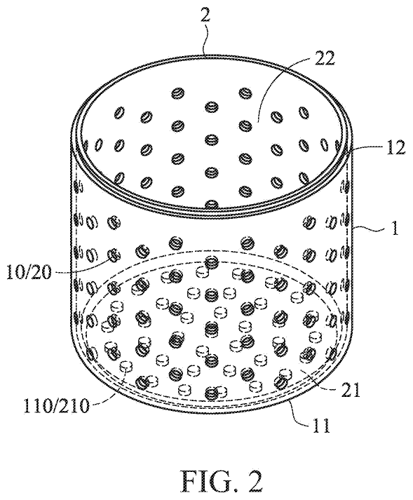

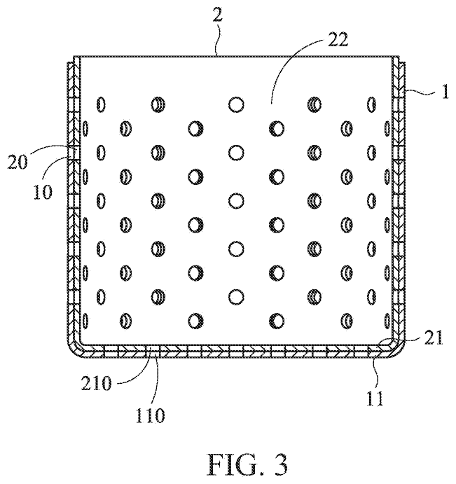

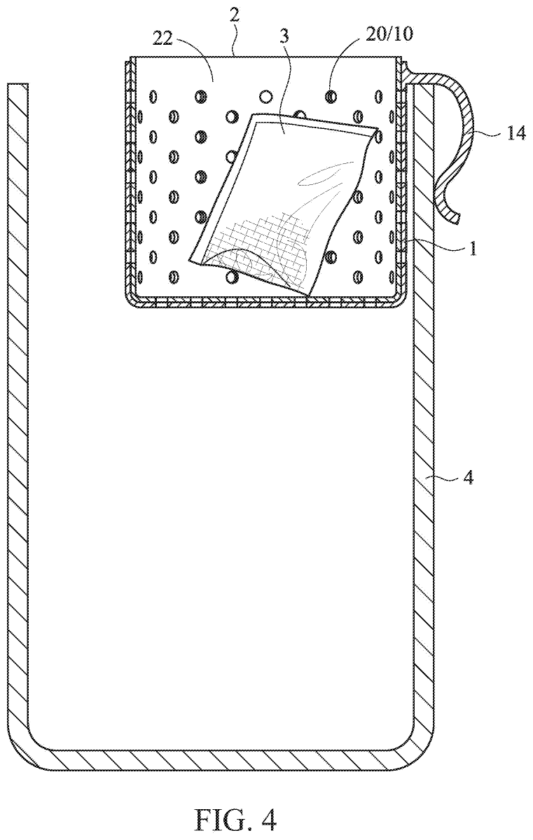

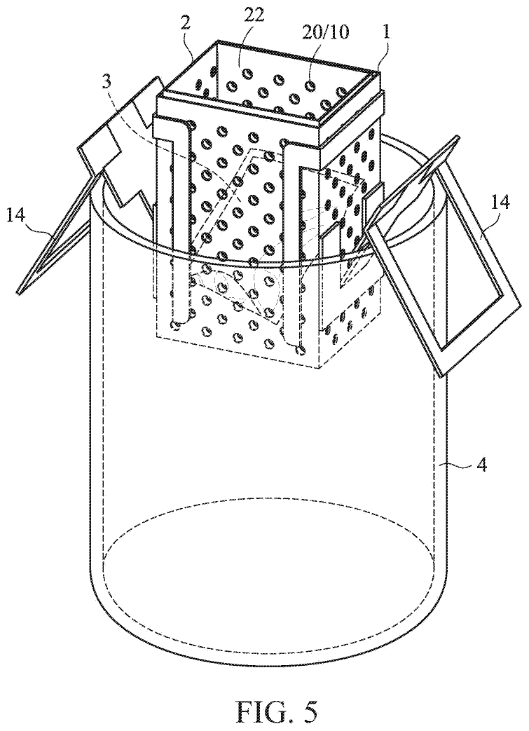

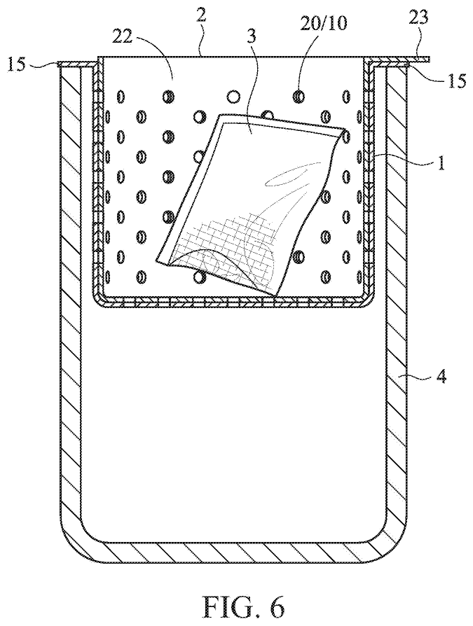

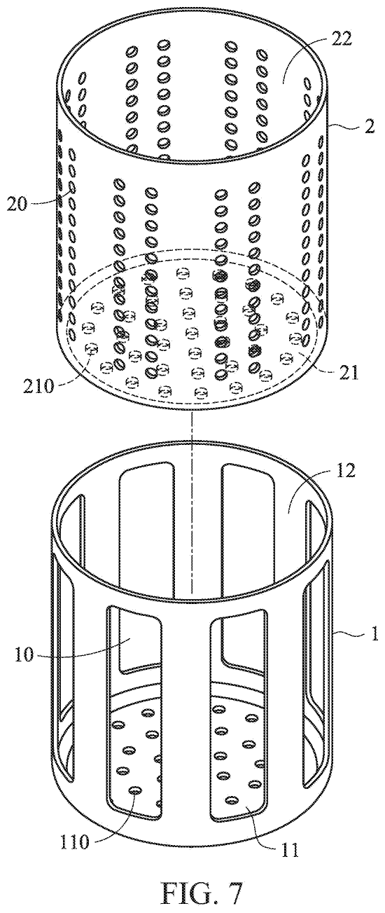

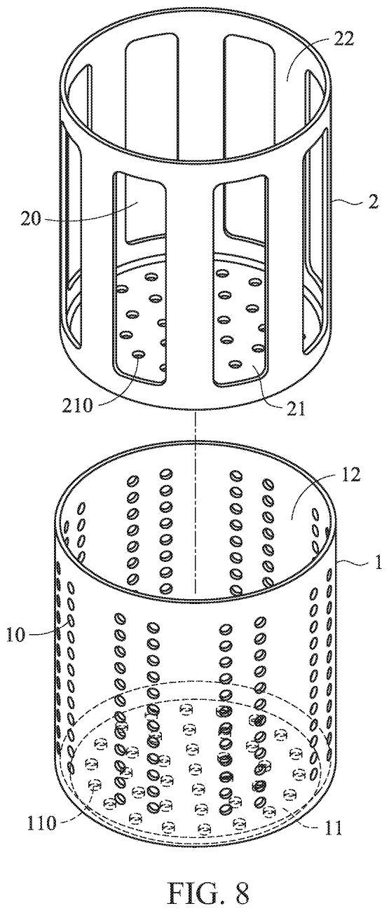

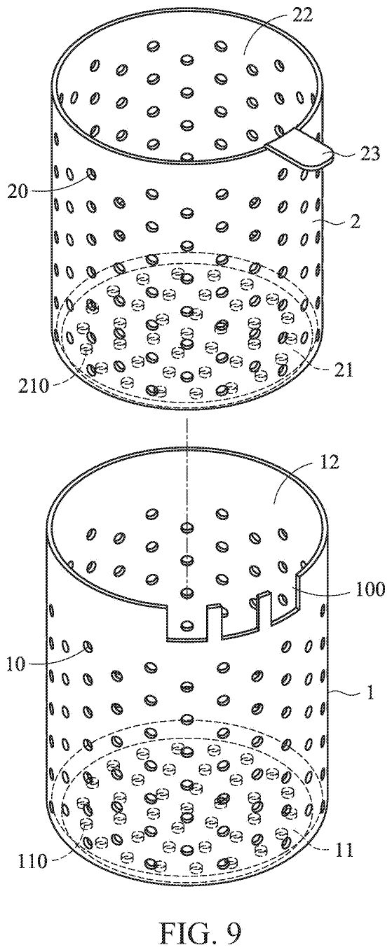

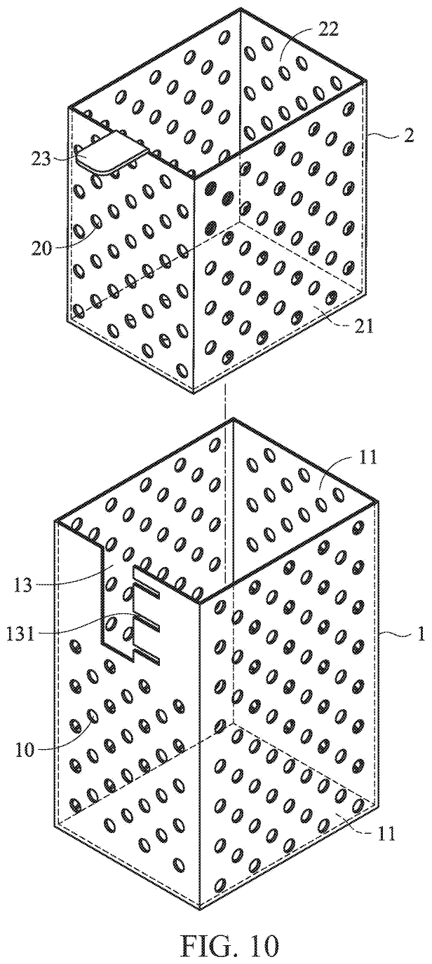

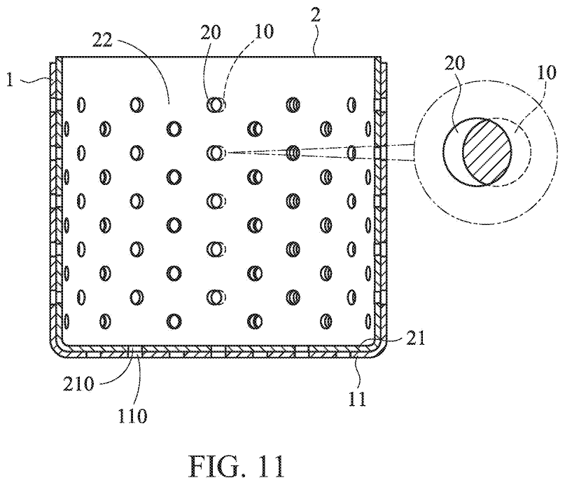

Referring from FIG. 1 to FIG. 11, wherein FIG. 1 is a perspective exploded view according to the present invention; FIG. 2 is a perspective view showing the assembly according to the present invention; FIG. 3 is a cross sectional view showing the assembly according to the present invention; FIG. 4 is a schematic view showing the outer cylinder being provided with a hooking hanger and being hanged inside the container according to one preferred embodiment of the present invention; FIG. 5 is a schematic view showing the outer cylinder being provided with two hooking hangers and being hanged inside the container according to one preferred embodiment of the present invention; FIG. 6 is a schematic view showing the periphery defined at the top end of the outer cylinder being formed with a flange outwardly extended and disposed at the top end of the container according to one preferred embodiment of the present invention; FIG. 7 is a schematic view showing the periphery of the outer cylinder being formed with axially-oriented rectangular penetrated holes and the periphery of the inner cylinder being correspondingly formed with round penetrated holes according to one preferred embodiment of the present invention; FIG. 8 is a schematic view showing the periphery of the outer cylinder being formed with a plurality of round penetrated holes and the periphery of the inner cylinder being correspondingly formed with axially-oriented rectangular penetrated holes according to one preferred embodiment of the present invention; FIG. 9 is a schematic view showing the upper portion of the outer cylinder being formed with at least one positioning recess according to one preferred embodiment of the present invention; FIG. 10 is a schematic view showing the upper portion of the outer cylinder being formed with at least one linear groove and a plurality of horizontal mounting grooves being transversally formed along the linear groove and sequentially arranged in the linear groove according to one preferred embodiment of the present invention; and FIG. 11 is a schematic view showing the outer cylinder and the inner cylinder being rotated for adjusting the dimension of the penetrated holes thereof according to one preferred embodiment of the present invention. According to one preferred embodiment, the present invention provides an adjustable brewer structure, which is applicable for an object to be brewed 3 and a container 4, and includes an outer cylinder 1 and an inner cylinder 2.

The outer cylinder 1 is disposed inside the container 4, the bottom end thereof is provided with a bottom plate 11 and the center of the outer cylinder 1 is formed with an accommodation space 12, the periphery of the outer cylinder 1 is formed with at least one penetrated hole 10, the bottom plate 11 of the outer cylinder 1 is formed with at least one penetrated hole 110, the at least one penetrated hole 10 formed at the periphery of the outer cylinder 1 is formed as an axially-oriented rectangular penetrated hole (as shown in FIG. 7) or formed as a plurality of round penetrate holes (as shown from FIG. 1 to FIG. 6 and from FIG. 9 to FIG. 10), the outer cylinder 1 is formed in a tubular shape (as shown from FIG. 1 to FIG. 9 and FIG. 11) or formed in a polygonal shape (as shown in FIG. 10), for example cubic shape or rectangular shape or triangular shape or pentagonal shape, but what shall be addressed is that the scope of the present invention is not limited to the above-mentioned arrangement; the top end defined at the periphery of the outer cylinder 1 is formed with a flange 15 (as shown in FIG. 6) which is outwardly extended and disposed at the top end of the container 4, the outer side of the outer cylinder 1 is formed with at least one hooking hanger 14 used for being hooked (as shown in FIG. 4) or hanged (as shown in FIG. 5) at the top end of the container 4. The upper portion of the outer cylinder 1 is further formed with at least one positioning recess 100 (as shown in FIG. 9), the upper portion of the outer cylinder 1 is formed with at least one linear groove 13 and a plurality of horizontal mounting grooves 131 (as shown in FIG. 10) transversally formed along the linear groove 13 and sequentially arranged.

The inner cylinder 2 is disposed in the accommodation space 12 of the outer cylinder 1, the bottom end of the inner cylinder 2 is provided with a bottom plate 21 and the center of the inner cylinder 2 is formed with an accommodation space 22 allowing the object to be brewed 3 to be accommodated therein, the periphery of the inner cylinder 2 is formed with at least one penetrated hole 20 corresponding to the penetrated hole 10 at the periphery of the outer cylinder 1, the inner cylinder 2 is formed in a tubular shape (as shown from FIG. 1 to FIG. 9 and FIG. 11) or formed in a polygonal shape (as shown in FIG. 10) which is corresponding to the tubular shape or the polygonal shape of the outer cylinder 1, the polygonal shape can be cubic shape or rectangular shape or triangular shape or pentagonal shape, but what shall be addressed is that the scope of the present invention is not limited to the above-mentioned arrangement; the bottom plate 21 of the inner cylinder 2 is formed with at least one penetrated hole 210 which is corresponding to the at least one penetrated hole 110 (as shown in FIG. 1 to FIG. 9 and FIG. 11) of the bottom plate 11 of the outer cylinder 1, the periphery of the inner cylinder 2 is formed with at least one penetrated hole 20, which can be formed as an axially-oriented rectangular penetrated hole (as shown in FIG. 8) or formed as a plurality of round penetrate holes (as shown from FIG. 1 to FIG. 7 and from FIG. 9 to FIG. 11) and corresponding to the at least one penetrated hole 10 at the periphery of the outer cylinder 1 which is formed as the plural round penetrate holes (as shown from FIG. 1 to FIG. 6 and from FIG. 8 to FIG. 11) or formed as the axially-oriented rectangular penetrated hole (as shown in FIG. 7), the upper portion of the inner cylinder 2 is provided with a turning plate 23 (as shown from FIG. 4 to FIG. 10), which is corresponding to the flange 15 outwardly extended from the top end or the upper portion of the outer cylinder 1 or the at least one positioning recess 100 (as shown in FIG. 9) or the plural horizontal mounting grooves 131 (as shown in FIG. 10) of the at least one linear groove 13; according to this embodiment, the bottom plate 11 of the outer cylinder 1 and the bottom plate 21 of the inner cylinder 2 are not formed with the above-mentioned penetrated holes 110, 210.

When the present invention is in use, the object to be brewed 3 is firstly disposed in the accommodation space 22 of the inner cylinder 2, then the inner cylinder 2 and the outer cylinder 1 are sleeved so as to be disposed inside the container 4, water is supplied into the container 4, if the dimension of the penetrate holes 10, 20 are desired to be adjusted, the inner cylinder 2 is clockwise or counterclockwise rotated in the outer cylinder 1 (as shown in FIG. 11) or the inner cylinder 2 is upwardly or downwardly adjusted relative to the outer cylinder 1, in other words the turning plate 23 is able to be mounted in at least one of the horizontal mounting grooves 131 (as shown in FIG. 10) which are sequentially arranged in the linear groove 13, so that the penetrated hole 10 of the outer cylinder 1 and the corresponding penetrated hole 20 of the inner cylinder 2 can be mutually staggered for forming a locking status or mutually aligned for forming an unlocking status so as to adjust the dimension, thereby allowing the concentration of the object to be brewed 3 to satisfy personal tastes. Based on the structure disclosed above, the present invention utilizes the outer cylinder 1 and the inner cylinder 2 which can be mutually sleeved and respectively provided with the bottom plates 11, 21, the periphery of the outer cylinder 1 having the flange 15 and the periphery of the inner cylinder 2 having the turning plate 23 are respectively formed with the at least one penetrated hole 10, 20 which are corresponding to each other, the upper portion of the outer cylinder 1 is formed with the positioning recess 100 or formed with the linear groove 13 having the horizontal mounting grooves 131 corresponding to the turning plate 23 of the inner cylinder 2; as such, via rotating or upwardly/downwardly displacing the inner cylinder 2 in the accommodation space 12 of the outer cylinder 1, the penetrated hole 20 of the inner cylinder 2 and the penetrated hole 10 of the outer cylinder 1 can be staggered or aligned, thereby controlling and adjusting the dimension of the penetrated holes 20, 10; thus, an efficient operating convenience is provided to the present invention, the concentration and flavor of the object to the brewed 3 accommodated in the accommodation space 22 of the inner cylinder 2 is able to be adjusted and can be individually served as a tea bag and disposed on the container 4 with a hanging or hooking manner; accordingly, the present invention is novel and more practical in use comparing to prior arts.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. An adjustable brewer structure, applicable for an object to be brewed and a container used for a purpose of brewing, and including:
an outer cylinder, disposed inside the container, wherein the bottom end thereof is provided with a bottom plate and the center of the outer cylinder is formed with an accommodation space, and the periphery of the outer cylinder is formed with at least one penetrated hole; and
an inner cylinder, disposed in the accommodation space of the outer cylinder, wherein the bottom end of the inner cylinder is provided with a bottom plate and the center of the inner cylinder is formed with an accommodation space allowing the object to be brewed to be accommodated therein, and the periphery of the inner cylinder is formed with at least one penetrated hole corresponding to the penetrated hole at the periphery of the outer cylinder.

2. The adjustable brewer structure as claimed in claim 1, wherein the shape of the outer cylinder and the shape of the inner cylinder are respectively formed in a corresponding tubular shape or a polygonal shape.

3. The adjustable brewer structure as claimed in claim 2, wherein the at least one penetrated hole at the periphery of the outer cylinder is formed as an axially-oriented rectangular penetrated hole or formed as a plurality of round penetrate holes.

4. The adjustable brewer structure as claimed in claim 3, wherein the at least one penetrated hole at the periphery of the inner cylinder is formed as an axially-oriented rectangular penetrated or formed as a plurality of round penetrate holes, and corresponding to the at least one penetrated hole at the periphery of the outer cylinder which is formed as the plural round penetrate holes or formed as the axially-oriented rectangular penetrated hole.

5. The adjustable brewer structure as claimed in claim 1, wherein the upper portion of the outer cylinder is formed with at least one positioning recess.

6. The adjustable brewer structure as claimed in claim 1, wherein the upper portion of the outer cylinder is formed with at least one linear groove and a plurality of horizontal mounting grooves transversally formed along the linear groove and sequentially arranged.

7. The adjustable brewer structure as claimed in claim 1, wherein the outer side of the outer cylinder is formed with at least one hooking hanger used for being hooked or hanged at the top end of the container.

8. The adjustable brewer structure as claimed in claim 1, wherein the top end defined at the periphery of the outer cylinder is formed with a flange, which is outwardly extended and disposed at the top end of the container.

9. The adjustable brewer structure as claimed from claims 1 to 8, wherein the upper portion of the inner cylinder is provided with a turning plate, which is corresponding to the flange outwardly extended from the top end or the upper portion of the outer cylinder or the at least one positioning recess or the plural horizontal mounting grooves of the at least one linear groove formed at the upper portion of the outer cylinder.

10. The adjustable brewer structure as claimed in claim 2, wherein the shape of the outer cylinder and the shape of the inner cylinder are formed in a corresponding tubular shape, the bottom plate of the outer cylinder and the bottom plate of the inner cylinder are respectively formed with at least one penetrated hole corresponding to each other.
